(19) United States
(12) Patent Application Publication
(10) Pub. No.: US 2016/0329796 A1
(43) Pub. Date: Nov. 10, 2016

(54) POWER GENERATION DEVICE, ARMATURE STRUCTURE FOR POWER GENERATION DEVICE, AND METHOD FOR MANUFACTURING ARMATURE

(71) Applicants: Manabu YAGI, Kagoshima (JP); HANO MANUFACTURING CO., Ltd., Fukuoka (JP)

(72) Inventors: Yoshiaki HANO, Fukuoka (JP); Manabu YAGI, Kagoshima (JP); Tuyoshi NISHITAMARI, Kagoshima (JP)

(21) Appl. No.: 15/214,804

(22) Filed: Jul. 20, 2016

Related U.S. Application Data
(63) Continuation of application No. PCT/JP2015/051399, filed on Jan. 20, 2015.

(30) Foreign Application Priority Data
Jan. 21, 2014 (JP) 2014-008791
Jan. 21, 2014 (JP) 2014-008792

(51) Int. Cl. H02K 21/24; H02K 15/02; H02K 16/02; H02K 9/02; H02K 3/26; H02K 15/04

(52) U.S. Cl. CPC H02K 21/24; H02K 3/26; H02K 15/0407; H02K 16/02; H02K 9/02; H02K 15/02

(57) ABSTRACT

A power generation device equipped with: two disk-shaped rotors that are fixed to a rotary shaft; a field system that has an even number of magnetic poles that are arranged on the same circumference, said magnetic poles comprising permanent. magnets that are fixed to the rotors in such a manner that the magnetization directions of the magnets are parallel to the axis of the rotary shaft with the directions being alternately arranged; and a stator that comprises coil substrates on which conductive patterns are formed so as to cross magnetic fluxes generated by the permanent magnets when the rotors rotate. Multiple conductive patterns corresponding to the number of phases are disposed in the stator, and electric power generated for each phase can be independently output.

### CROSS-REFERENCE TO RELATED APPLICATION

The present application is a continuation application of International Patent Application No. PCT/JP2015/051399 which was filed in Japanese language on Jan. 20, 2015 and claims priority under Article 8 of the Patent Cooperation Treaty (PCT) to Japanese Patent. Applications Nos. 2014-008791 and 2014-008792 both of which were filed on Jan. 21, 2014. Japanese Patent. Application No. 2014-008791, Japanese Patent Application No. 2014-008792, and International Patent Application No. PCT/JP2015/051399 are hereby incorporated by reference in their entirety.

### FIELD OF THE INVENTION

The present invention relates to a device for generating electric power, fbr instance, in wind power generation, hydraulic power generation, and tidal power generation. The present invention relates further to an armature to be equipped in the power generation device, and further to a method of manufacturing the armature.

### BACKGROUND ART

In recent years, electric power generation based on recyclable energy, such as wind power generation, hydraulic power generation, and tidal power generation has drawn attention and has been put to practical use in place of electric power generation based on energy which will be exhausted, such as atomic power generation and thermal power generation.

For instance, wind power generation has advantages that greenhouse effect gas and burned ashes are not generated, and further, radioactive wastes are not generated, because natural energy is used for wind power generation.

On the other hand, wind power generation has disadvantages that it is remarkably effected by time zones, seasons and climate, and hence, it is difficult to stably generate electric power.

A conventional device fbr generating electric power is designed to include a permanent magnet rotatable with a windmill for defining a magnetic field, and a stator having an iron core formed with an extended pole around which a wire is wound.

However, the conventional device is accompanied with a problem that since a force for absorbing magnetism is generated between the permanent magnet and the extended pole, the windmill cannot rotate, and hence, electric power cannot be generated, if a wind having an intensity insufficient to overcome the force acts on the windmill. Furthermore, the above-mentioned force for absorbing magnetism causes so-called cogging, that is, irregularity in torque per a rotation of a rotation shaft of the electric power generating device, resulting in that the rotation shaft is not able to smoothly rotate.

As a solution to the above-mentioned problems, there have been suggested patent documents 1 and 2.

The patent document 1 suggests a device for generating electric power, including a magnet for generating magnetic fluxes, a magnetic substance for preventing reduction of a density of the magnetic fluxes generated by the magnet, in atmosphere, and a coil situated between the magnet and the magnetic substance, and having a plurality of substantially triangular portions around each of which a wire is wound. The magnet and the coil are designed to be movable relative to each other. The magnet and the magnetic substance are designed to be spaced away from each other by a constant distance, even if the magnet and the coil move relatively to each other.

The patent document 2 suggests a device for generating electric power, including a first rotation input part arranged to be situated at a first position on a base axis and to have a rotation axis extending coaxially with the base axis, and to receive flow of fluid acting as power-generation source to rotate in a first direction, a second rotation input part arranged to be situated at a second position on the base axis, the second position being different from the first position, and to receive flow of the fluid in the same direction to rotate in a direction opposite to the first direction, a first rotor equipped with a magnet for generating a magnetic system, and a second rotor rotatable together with the second rotation input part in a direction opposite to the direction in which the first rotor rotates, and having a coil to be magnetized by the magnet. In the device for generating electric power, the coil and magnet are arranged to face each other such that air gap is generated in a direction of the rotation axis. In the second rotor, a plurality of the coils each of which has air core and is flat is arranged around the rotation axis such that each of rotation axes of the coils extends coaxially with the rotation axis. In the first rotor, a plurality of the magnets is arranged around the rotation axis such that each of the magnets is magnetized in a direction of the rotation axis, to thereby define an axial gap type device for generating electric power.

### PRIOR ART DOCUMENTS

### Patent Documents

Patent document 1: Japanese Patent Application Publication No. 2002-10573

Patent document 2: Japanese Patent Application Publication No. 2008-82251

### DISCLOSURE OF THE INVENTION

### Problems to be Solved by the Invention

In the electric-power generation devices suggested in the above-mentioned patent documents 1 and 2, the coils used for electric power generation are characterized by that no cogging occurs, because the coils have air core, are flat, and have no protruded poles. However, the coils are generally manufactured by winding a wire a plurality of times, and accordingly, it takes much work volume, even if a wire is wound manually or mechanically. Furthermore, a coil comprised of a wire having a circular cross-section is said to be able to have a fill factor of 65% at maximum. This means that it is difficult to have a lot of turns in a given space.

In view of the above-mentioned problems in the prior art, it is an object of the present invention to provide a device for generating electric power making it unnecessary to carry out a step of winding a wire for manufacturing a coil, being able to have a higher fill factor than a wire, and preventing cogging from occurring, and further provide an armature to be equipped in the device, and a method of manufacturing the armature.

### Solution to the Problems

In order to solve the above-mentioned problems, the present invention in accordance with the first aspect provides a device for generating electric power, including a disc-shaped rotor fixed to a rotation shaft, a magnetic field including an even number of magnetic poles arranged on a common circumference, the magnetic poles comprising permanent magnets fixed to the rotor, being magnetized in a direction in parallel with an axis of the rotor, and being magnetized in alternate directions, and a stator including coil substrates on which electrically conductive patterns are formed so as to cross magnetic fluxes generated by the magnetic field when the rotor is in rotation, wherein the electrically conductive patterns of the stator are formed in dependence on a number of phases such that electric power generated in each of phases can be output independently of one another.

In the first aspect of the present invention, since the coil substrates on which electrically conductive patterns are formed are employed as a coil to be used for generating electric power, it is possible to increase a fill factor relative to a coil comprised of a wound wire, to make it unnecessary to carry out a step of winding a coil, and to prevent occurrence of togging. By designing the device to include a plurality of sets of the coil substrates and the rotors, it is possible to generate electric power in a plurality of phases.

The second aspect of the present invention is characterized in that, in the first aspect of the present invention, two rotors and magnetic fields are respectively spaced away from each other by a predetermined distance in a longitudinal direction of the rotation shaft, the magnetic fields are arranged such that opposite poles face each other, and the stator is disposed between the magnetic fields facing each other.

In accordance with the second aspect of the present invention, a magnetic field having a high intensity is generated between the two magnetic systems, and the electric conductive patterns of the stator situated between the magnetic systems are able to cross a lot of magnetic fluxes, resulting in an increase in electric power generation.

The third aspect of the present invention is characterized in that, in the first or second aspect of the present invention, each of the electrically conductive patterns is formed by etching a copper film formed on a printed circuit board. In accordance with the third aspect of the present invention, it is possible to manufacture the electric conductive patterns by means of conventional etching processes.

The fourth aspect of the present invention is characterized in that, in the first to third aspects of the present invention, a plurality of the coil substrates is stacked one on another to define a coil having a predetermined number of turns.

In accordance with the fourth aspect of the present invention, it is possible to increase a number of coil substrates and a number of turns in each of coil substrates, resulting in an increase in a voltage of the generated electric power.

The fifth aspect of the present invention is characterized in that, in the first to fourth aspects of the present invention, the device includes a plurality of sets of the coil substrate and the rotor to define a coil having a predetermined number of turns.

In accordance with the fifth aspect of the present invention, it is possible to increase a number of coil substrates and a number of turns in each of coil substrates, resulting in an increase in a voltage of the generated electric power.

The sixth aspect of the present invention is characterized in that, in the first to fifth aspects of the present invention, the stator and the rotor are housed in a cylindrical casing.

In accordance with the sixth aspect of the present invention, it is possible to protect the stator and the rotor, and to surely fix the coil substrates of the stator in the casing.

The seventh aspect of the present invention is characterized in that, in the sixth aspect of the present invention, the rotation shaft is rotatably supported by the casing through a bearing.

In accordance with the seventh aspect of the present invention, it is possible to allow the rotor fixed to the rotation shaft to make smooth rotation.

The eighth aspect of the present invention is characterized in that, in the first to seventh aspects of the present invention, the rotor is formed with an air circulation hole through which an air flows to cool down the coil substrates of the stator.

In accordance with the eighth aspect of the present invention, the rotation of the rotor generates convective air flow, resulting in that the coil substrates of the stator are cooled.

The ninth aspect of the present invention is characterized in that, in the first to eighth aspects of the present invention, the rotor is formed with a fin or a groove through which an air flows to cool down the coil substrates of the stator. In accordance with the ninth aspect of the present invention, the rotation of the rotor generates convective air flow, resulting in that the coil substrates of the stator are cooled.

The present invention in accordance with the tenth aspect provides an armature unit to be equipped in a device for generating electric power, including a disc-shaped rotor fixed to a rotation shaft, a magnetic field including an even number of magnetic poles arranged on a common circumference, the magnetic poles comprising permanent magnets fixed to the rotor, being magnetized in a direction in parallel with an axis of the rotor, and being magnetized in alternate directions, and a stator including an armature comprising an electric power generating coil crossing magnetic fluxes generated by the magnetic field when the rotor is in rotation, wherein the electric power generating coil is comprised of electrically conductive patterns formed on a surface of a coil substrate made of an electrically insulative material, and the electrically conductive pattern are formed in dependence on a number of phases such that electric power generated in each of phases can be output independently of one another.

In the tenth aspect of the present invention, since the coil substrates on which electrically conductive patterns are formed are employed as a coil to be used for generating electric power, it is possible to increase a fill factor relative to a coil comprised of a wound wire, and to make it unnecessary to carry out a step of winding a coil. By designing the device to include a plurality of the coil substrates, it is possible to generate electric power in a plurality of phases.

The eleventh aspect of the present invention is characterized in that, in the tenth aspect of the present invention, electrically insulative layers and electrically conductive layers each including an electrically conductive pattern are alternately stacked one on another, and a point at which an electrically conductive pattern terminates to be wound in a layer is electrically connected through a plated through hole to a point at which an electrically conductive pattern starts to be wound in a next layer in a common phase to thereby define an electrically conductive pattern having a predetermined number of turns.

In accordance with the eleventh aspect of the present invention, it is no longer necessary to electrically connect the electrically conductive patterns through wires in each of phases, making it possible to delete a step of electrically connecting the electrically conductive patterns to one another, and to prevent the electrically conductive patterns from being wrongly electrically connected to one another.

The twelfth aspect of the present invention is characterized in that, in the eleventh aspect of the present invention, the electric power generating coil includes four electrically conductive patterns, and an electrically conductive pattern situated outermost among the four electrically conductive patterns includes an electrically conductive layer on which a connection land is formed through an electrically insulative layer.

In accordance with the twelfth aspect of the present invention, it is no longer necessary to arrange wires for outputting generated electric power.

The thirteenth aspect of the present invention is characterized in that, in the eleventh or twelfth aspect of the present invention, a through hole through which a point at which an electrically conductive pattern in a layer terminates to be wound and a point at which an electrically conductive pattern in a next layer starts to be wound are electrically connected to each other, or through which the electrically conductive pattern situated outermost among the four electrically conductive patterns is electrically connected to the connection land is comprised of a plurality of apertures, each of which plated to electrically connect to the connection land.

In accordance with the thirteenth aspect of the present invention, it is possible to make a circumferential length longer, ensuring that a resistance and a heat quantity caused by the resistance can be reduced, even if a plating layer with which a through hole is plated had a small thickness.

The present invention in accordance with the fourteenth aspect provides a method of manufacturing an armature unit to be equipped in a device for generating electric power, including adhering first and second metal layers onto upper and lower surfaces of an electrically insulative substrate, etching the first and second metal layers to form first and second electrically conductive patterns each having a function of a first-phase electric power generating coil and a second-phase electric power generating coil, respectively, coating electrically insulative layers on upper and lower surfaces of the first and second electrically conductive patterns, adhering third and fourth metal layers onto upper and lower surfaces of each of the electrically insulative layers, etching the third and fourth metal layers to form third and fourth electrically conductive patterns, the third electrically conductive pattern having a function of a third-phase electric power generating coil, the fourth electrically conductive pattern having a function of a lead pattern, and electrically connecting a point at which each of the first to third electrically conductive patterns starts or terminates to be wound, to the fourth electrically conductive pattern through a plated through hole.

An armature having a fundamental structure of a three-phase electric-power generation coil can be manufactured by the method.

The present invention in accordance with the fifteenth aspect provides a method of manufacturing an armature unit to be equipped in a device for generating electric power, including stacking a requisite number of armatures one on another to define an electric power generating coil having a predetermined number of turns, the armature being manufactured in accordance with the method defined as the fourteenth aspect.

The present invention in accordance with the sixteenth aspect provides a method of manufacturing an armature unit to be equipped in a device for generating electric power, including stacking fifth, sixth and seventh electrically conductive patterns onto the first, second and third electrically conductive patterns to lay each of phases in the first to third electrically conductive patterns over each of phases in the fifth to seventh electrically conductive patterns, the fifth, sixth and seventh electrically conductive patterns each having tops and bottoms located oppositely to tops and bottoms of the first, second and third electrically conductive patterns, respectively, in the case that the armature unit manufactured in accordance with the method defined as the fourteenth aspect includes electrically conductive patterns having alternately located tops and bottoms.

In accordance with the sixteenth aspect of the present invention, it is possible to manufacture a single coil unit. Furthermore, an electric-power generation coil having a predetermined number of turns can be manufactured by stacking a plurality of coil units and electrically connecting the coil units to one another.

### ADVANTAGES PROVIDED BY THE INVENTION

The present invention provides a device for generating electric power making it unnecessary to carry out a step of winding a wire for manufacturing a coil, being able to have a higher fill factor than a wire, and preventing cogging from occurring, and further provides an armature to be equipped in the device.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIGS. 1(a), 1(b), and 1(c) illustrate a structure of a device for generating electric power in accordance with the first embodiment of the present invention. FIG. 1(a) is a front view, FIG. 1(b) is a cross-sectional view taken along the line A-A shown in FIG. 1(a), and FIG. 1(c) is a cross-sectional view taken along the line B-B shown in FIG. 1(b).

FIG. 2 is a front view illustrating an electrically conductive pattern of a u-phase in a first substrate in the first embodiment of the present invention.

FIG. 3 is a front view illustrating an electrically conductive pattern of a v-phase in a first substrate in the first embodiment of the present invention.

FIG. 4 is a front view illustrating an electrically conductive pattern of a w-phase in a first substrate in the first embodiment of the present invention.

FIG. 5 is a front view illustrating a terminal portion of a first substrate in the first embodiment of the present invention.

FIG. 6 is a front view illustrating a first substrate on which all of phases are formed in the first embodiment of the present invention.

FIG. 7 is a front view illustrating an electrically conductive pattern of a u-phase in a second substrate in the first embodiment of the present invention.

FIG. 8 is a front view illustrating an electrically conductive pattern of a v-phase in a second substrate in the first embodiment of the present invention.

FIG. 9 is a front view illustrating an electrically conductive pattern of a w-phase in a second substrate in the first embodiment of the present invention.

FIG. 10 is a front view illustrating a terminal portion of a second substrate in the first embodiment of the present invention.

FIG. 11 is a front view illustrating a second substrate on which all of phases are formed in the first embodiment of the present invention.

FIG. 12 illustrates steps of manufacturing an armature to be equipped in a device for generating electric power, in accordance with the present invention.

FIG. 13 illustrates a structure of an armature manufactured by a method in accordance with the present invention.

FIGS. 14(a) and 14(b) illustrate examples of a through hole to be formed through a substrate. FIG. 14(a) is an enlarged plan view of a substrate in which a single through hole TH is formed, and FIG. 14(b) is an enlarged view of a substrate in which small through holes TH1 to TH7 are formed in the second embodiment.

FIG. 15(a) is a graph showing a relation among a number of layers to be stacked one on another for defining a substrate, costs, a voltage to be generated, and a resistance loss.

FIGS. 16(a) and 16(b) illustrate a device for generating electric power in accordance with the third embodiment, which is designed to have an air cooling structure. FIG. 16(a) is a cross-sectional view of the device, and FIG. 16(b) is a front view of a rotor.

FIGS. 17(a) and 17(b) illustrate another example of an air cooling structure. FIG. 17(a) is a cross-sectional view of an air cooling structure having an aperture through which air is circulated, the aperture extending obliquely relative to a rotation axis, and FIG. 17(b) is a front view of an example of a rotor formed with a fin or a groove.

### EMBODIMENT(S) FOR REDUCING THE INVENTION TO PRACTICE

The first embodiment in accordance with the present invention is explained hereinbelow in detail with reference to drawings.

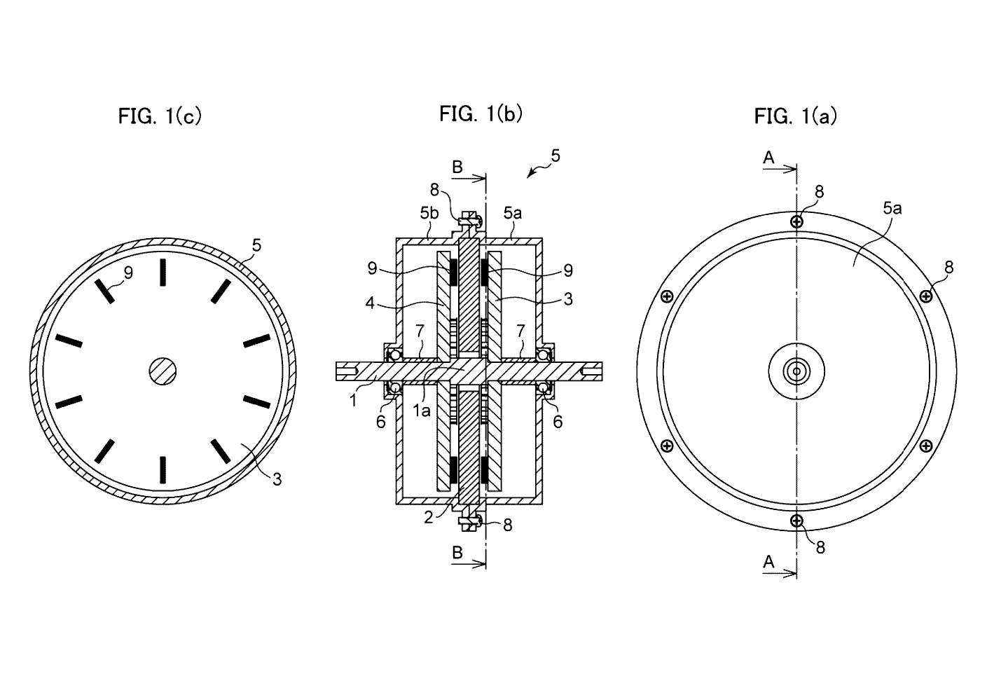

FIG. 1 illustrates a device for generating electric power in wind power generation in accordance with the first embodiment of the present invention. In the device, a stator 2 is situated independently of a rotation shaft 1 at a center in a length-wise direction of the rotation shaft 1. A first rotor 3 and a second rotor 4 are fixed to the rotation shaft 1 such that the first rotor 3 and the second rotor 4 face opposite surfaces of the stator 2. The rotation shaft 1 is formed centrally with a greater-diameter portion 1a by which the first rotor 3 and the second rotor 4 are prohibited to move towards each other beyond the greater-diameter portion 1a. Thus, the greater-diameter portion 1a defines an interval between the first rotor 3 and the second rotor 4.

A casing 5 comprised of a first casing 5a and a second casing 5b is assembled to the rotation shaft 1 in a rotatable manner through bearings 6. The casing 5 is fixed to another portion (not illustrated) such that the casing 5 cannot move while the rotation shaft 1 is in rotation. Bushes 7 are sandwiched between the bearing 6 and the first rotor 3 and between the bearing 6 and the second rotor 4 so as to prevent the first rotor 3 and the second rotor 4 from moving from their original positions. The first rotor 3 and the second rotor 4 may be prevented from moving from their original positions by means of any manners other than the bushes. The stator 2 is sandwiched between flanges of the first and second casings 5a and 5b , and the flanges are fixed to each other through bolts 8 to thereby fix the stator 2 between the flanges. A wedge or wedges may be employed to fix the stator 2 to the casing 5 in order to prevent the stator from shifting in a rotational direction.

A plurality or even number of permanent magnets 9 are fixed onto both the first rotor 3 and the second rotor 4. The permanent magnets 9 are magnetized in a length-wise direction of the rotation shaft 1, and are arranged such that permanent magnets located adjacent to each other are alternately magnetized. In the first embodiment, a number of the permanent magnets 9 is 10 (ten), where the ten permanent magnets are situated on a certain circumference by every 36 degrees.

The permanent magnets 9 fixed onto the first rotor 3 fixed to the rotation shaft 1 and the permanent magnets 9 fixed onto the second rotor 4 fixed to the rotation shaft 1 are arranged such that opposite magnetic poles of the permanent magnets 9 face each other.

The stator is comprised of a plurality of coil substrates stacked one on another.

As an alternative, a plurality of the first rotors 3 and/or a plurality of the second rotors 4 may be fixed to the rotation shaft 1 so as to define a coil or coils having a predetermined number of turns.

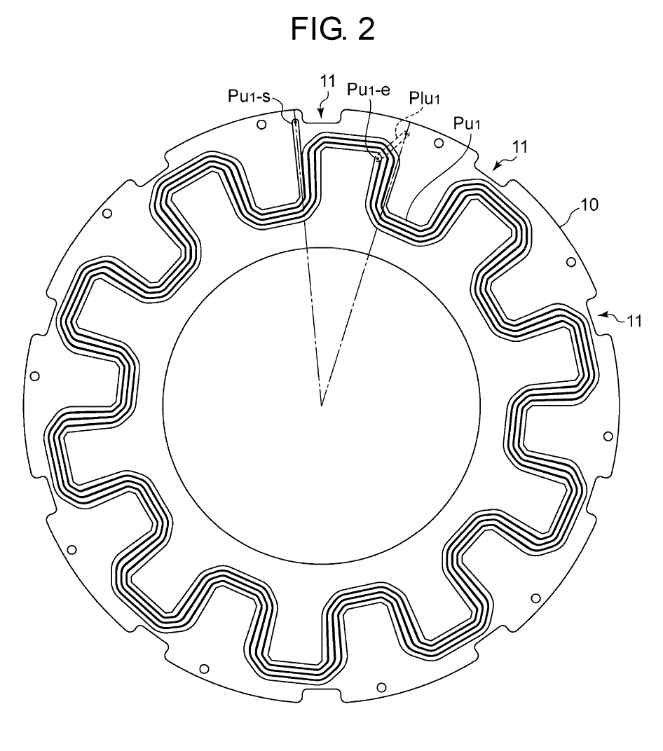

FIG. 2 illustrates a layer of a u-phase electrically conductive pattern Pu1 among three phases (u-phase, v-phase and w-phase) to be formed on a first substrate 10. The u-phase electrically conductive pattern Pu1 starts being wound at a starting point Pu1-s, defines four rows of patterns each comprising ten projected or recesses portions, and terminates being wound at a termination point Pu1-e, from )which the u-phase electrically conductive pattern Pu1 extends outside of the first substrate by means of a lead pattern Plu1 through plated through holes after substrates were stacked one on another. The first substrate 10 is formed at a circumference thereof with ten cut-outs 11 by every 36 degrees for positioning the first substrate 10.

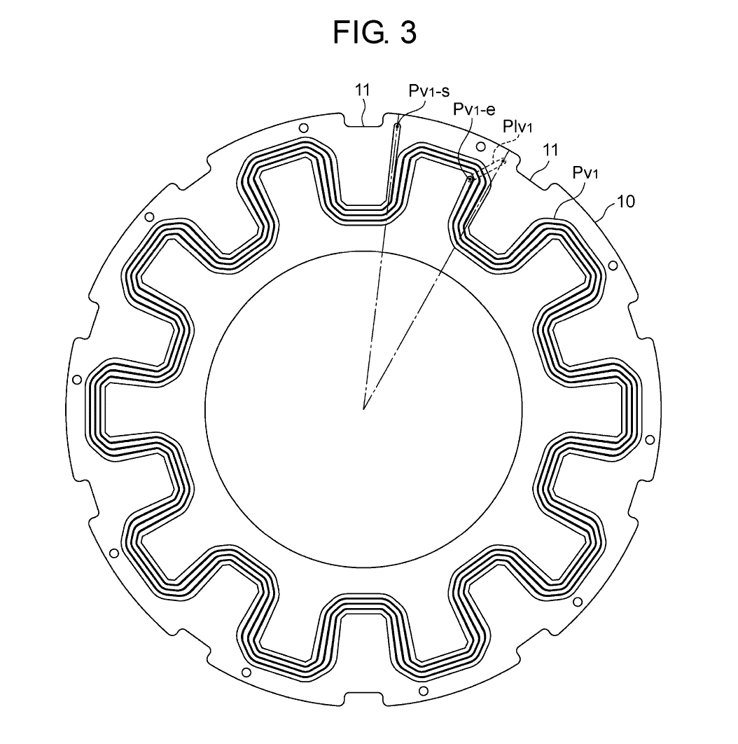

FIG. 3 illustrates a layer of a v-phase electrically conductive pattern Pv1 to be formed on the first substrate 10. The v-phase electrically conductive pattern Pv1 starts being wound at a starting point Pv1-s, defines four rows of patterns each comprising ten projected or recesses portions, and terminates being wound at a termination point Pv1-e, from which the v-phase electrically conductive pattern Pv1 extends outside of the first substrate by means of a lead pattern Plv1 through plated through holes after substrates were stacked one on another.

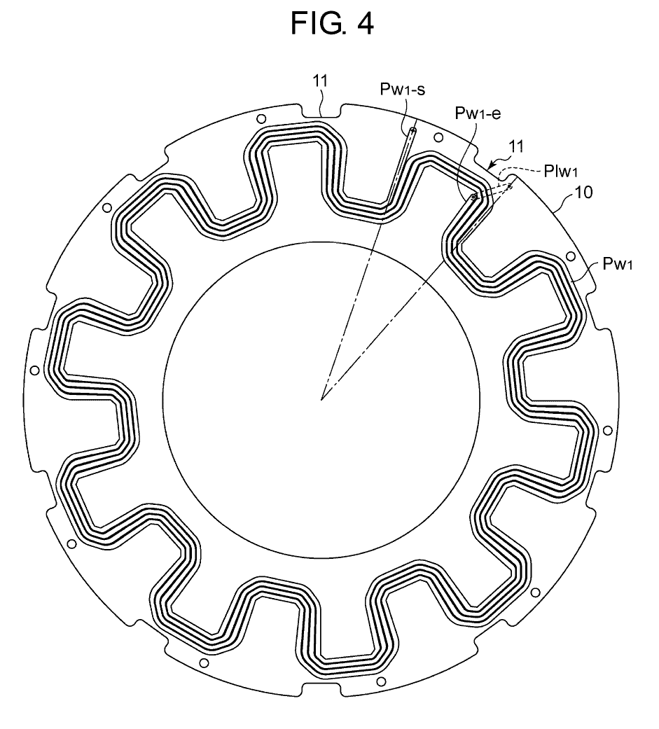

FIG. 4 illustrates a layer of a w-phase electrically conductive pattern Pw1 to be formed on the first substrate 10. The w-phase electrically conductive pattern Pw1 starts being wound at a starting point Pw1-s, defines four rows of patterns each comprising ten projected or recesses portions, and terminates being wound at a termination point Pw1-e, from which the w-phase electrically conductive pattern Pw1 extends outside of the first substrate by means of a lead pattern Plw1 through plated through holes after substrates were stacked one on another.

The u-phase electrically conductive pattern Pu1, the v-phase electrically conductive pattern Pv1, and the w-phase electrically conductive pattern Pw1 have a phase difference by 120 degrees in the unit of an electric angle. In the first embodiment, each of the electrically conductive patterns is designed to have ten magnetic poles, and hence, the electrically conductive patterns are arranged on the first substrate 10 such that each of them has an angular difference relative to one another by 12 degrees (a mechanical angle).

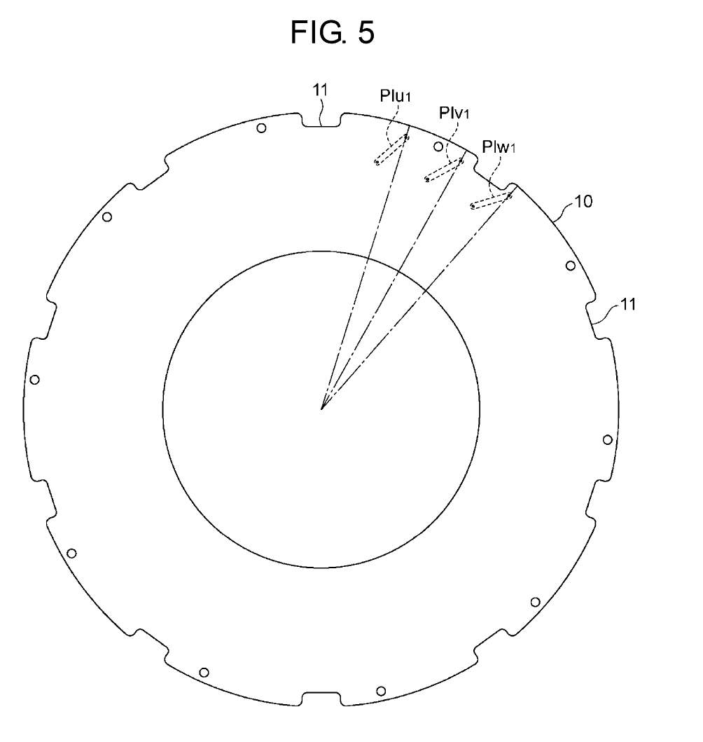

FIG. 5 illustrates a layer in which the lead patterns Plu1, Plv1 and Plw1 of each of the phases are formed. A start end of each of the lead patterns is electrically connected to each of the termination points Pu1-e, Pv1-e and Pw1-e of each of the phases through a plated through-hole after the substrates were stacked one on another.

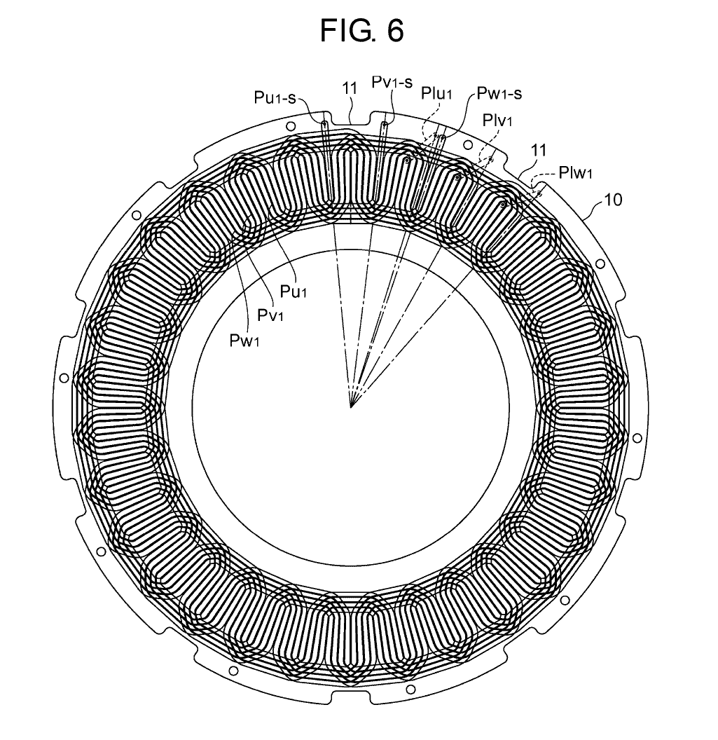

FIG. 6 illustrates all of the electrically conductive patterns and all of the lead patterns. In view of FIG. 6, it is understood that the phases are formed on the first substrate 10 by 12 degrees of an angular difference, and that the starting points and the termination points of the electrically conductive patterns in the phases are pulled out of the first substrate without being overlap one another.

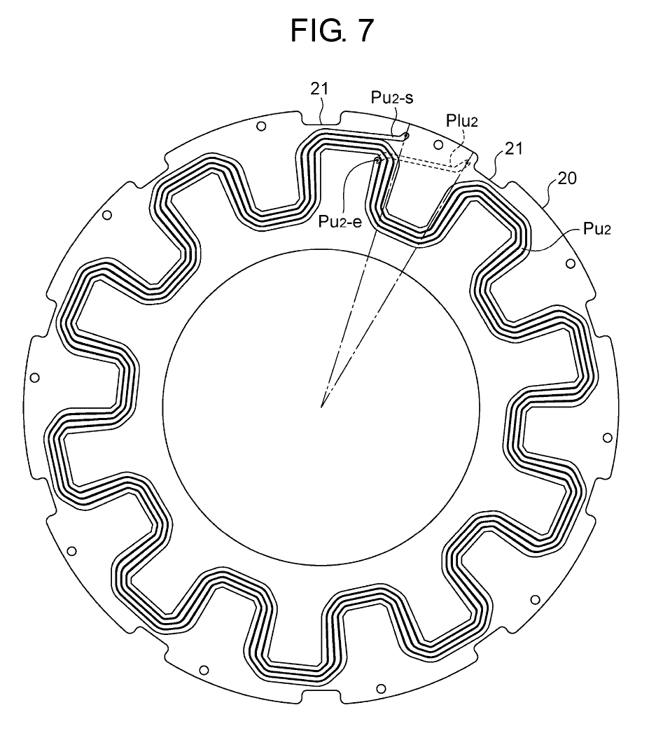

FIG. 7 illustrates a layer of a u-phase electrically conductive pattern Pu2 among three phases (u-phase, v-phase and w-phase) to be formed on a second substrate 20. The u-phase electrically conductive pattern Pu2 starts being wound at a starting point Pu2-s, defines four rows of patterns each comprising ten projected or recesses portions, and terminates being wound at a termination point. Pu2-e, from which the u-phase electrically conductive pattern Pu2 extends outside of the second substrate by means of a lead pattern Plu2 through plated through holes after the substrates were stacked one on another. The second substrate 20 is formed at a circumference thereof with ten cut-outs 21 by every 36 degrees for positioning the second substrate 20.

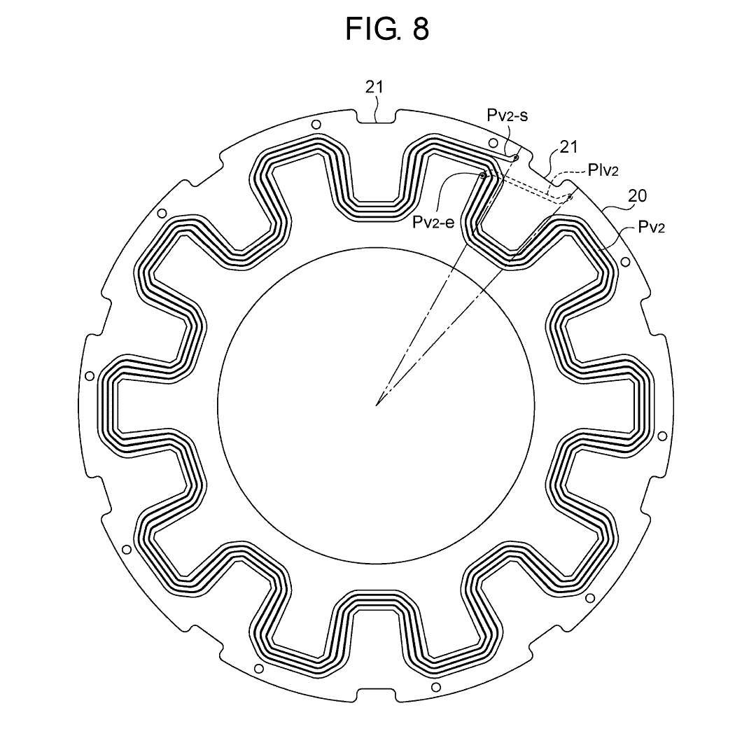

FIG. 8 illustrates a layer of a v-phase electrically conductive pattern Pv2 to be formed on the second substrate 20. The v-phase electrically conductive pattern Pv2 starts being wound at a starting point. Pv2-s, defines four rows of patterns each comprising ten projected or recesses portions, and terminates being wound at a termination point Pv2-e, from which the v-phase electrically conductive pattern Pv2 extends outside of the second substrate by means of a lead pattern Plv2 through plated through holes after the substrates were stacked one on another.

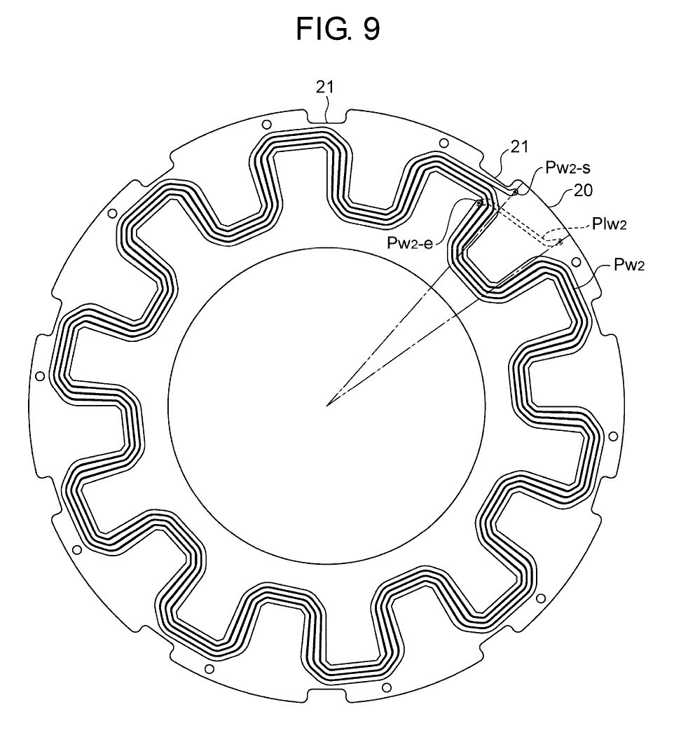

FIG. 9 illustrates a layer of a w-phase electrically conductive pattern Pw2 to be formed on the second substrate 20. The w-phase electrically conductive pattern Pw2 starts being wound at a starting point Pw2-s, defines four rows of patterns each comprising ten projected or recesses portions, and terminates being wound at a termination point Pw2-e, from which the w-phase electrically conductive pattern Pw2 extends outside of the second substrate by means of a lead pattern Plw2 through plated through holes after the substrates were stacked one on another.

The u-phase electrically conductive pattern Pu2, the v-phase electrically conductive pattern Pv2, and the w-phase electrically conductive pattern Pw2 are formed on the second substrate 20 such that they have a phase difference by 120 degrees, similarly to the first substrate 10.

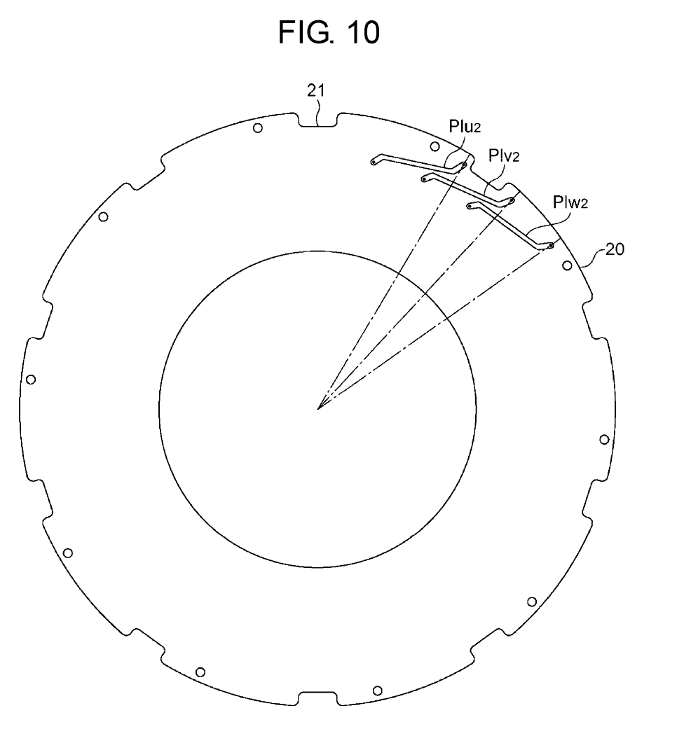

FIG. 10 illustrates a layer in which the lead patterns Plu2, Plv2 and Plw2 of each of the phases are formed. A start end of each of the lead patterns is electrically connected to each of the termination points Pu2-e, Pv2-e and Pw2-e of each of the phases through a plated through-hole after the substrates were stacked one on another.

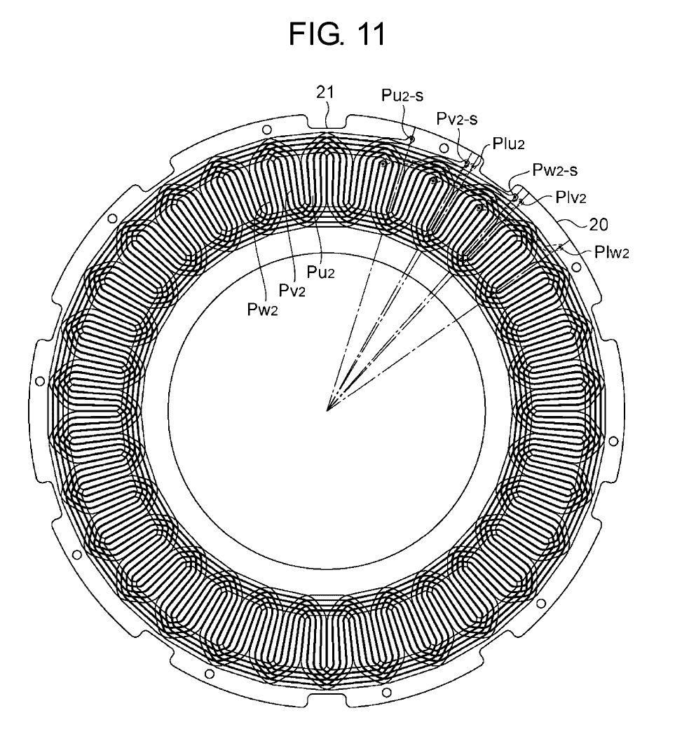

FIG. 11 illustrates all of the electrically conductive patterns and all of the lead patterns. In view of FIG. 11, it is understood that the phases are formed on the second substrate 20 by 12 degrees of an angular difference, and that the starting points and the termination points of the electrically conductive patterns in the phases are pulled out of the second substrate without being overlap one another.

The electrically conductive patterns in each of the phases, formed on the first substrate 10 and the electrically conductive patterns in each of the phases, formed on the second substrate 20 are designed to deviate from each other by 0.5 cycle (18 degrees of circumference). For instance, with respect to the u-phase, a location of a leading edge of the lead pattern Phu1 in the first substrate 10 is coincident with a location of a leading edge of the starting point Pu1-s at which the u-phase electrically conductive pattern Pu1 starts being wound in the second substrate 20. These electrically conductive patterns can be electrically connected in series with each other through a plated through hole.

A location of a leading edge of the lead pattern Plu2 electrically connected to the termination point of the u-phase electrically conductive pattern Pu2 in the second substrate 20 deviates in 36 degrees from a location of the starting point Pu1-s of the u-phase electrically conductive pattern Pu1 in the first substrate 10 (this is common to the other phases). Accordingly, an electrically conductive pattern deviating in 36 degrees from an electrically conductive pattern formed on the first substrate 10 is stacked on an underlying electrically conductive pattern on the second substrate 20, and these electrically conductive patterns are electrically connected to each other through a plated through hole. Thus, the electrically conductive patterns are electrically connected in series with each other, ensuring to increase a number of turns. By repeating a step of stacking an electrically conductive pattern on an underlying electrically conductive pattern with 36 degrees deviation in an angle of circumference until a total of the deviation reaches 360 degrees, it is possible to electrically connect the electrically conductive patterns in series to each other by 20 layers for each of the phases, totally by 60 layers.

The first and second substrates 10 and 20 are formed at a circumference thereof with the cut-outs 11 and 21 by every 36 degrees. Since the cut-outs 11 and 21 align with each other when the electrically conductive layers are stacked one on another with deviation in 36 degrees of circumference, the first and second substrates 10 and 20 can be readily aligned with each other. The casings 5a and 5b are formed, at inner surfaces thereof between which the stator 2 is sandwiched, with projections to be fit into the cut-outs 11 and 21, ensuring is possible to prevent the stator 2 from rotating around the rotation shaft 1.

By fixing a windmill to the rotation shaft 1 in the electric-power generation device having the above-mentioned structure, it is possible to accomplish a wind power generation device capable of rotating even by breeze without cogging.

Furthermore, since a coil can be manufactured to be thin in order to have a high fill factor and to efficiently generate a magnetic system, it is possible to convert a rotational force generated by a windmill into electric power with high efficiency.

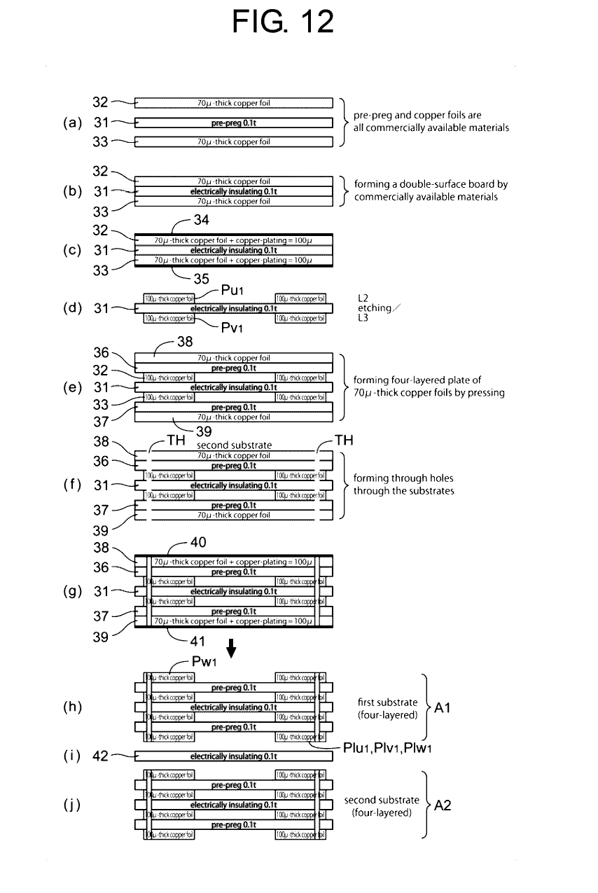

FIG. 12 illustrates steps of manufacturing the armature in accordance with the first embodiment of the present invention.

First, as illustrated in FIG. 12(a), copper foils 32 and 33 are laid on upper and lower surfaces of an electrically insulating substrate 31 comprised of a pre-preg, f′or instance. Then, as illustrated in FIG. 12(b), the copper foils and the pre-preg are integrally pressed into a piece. Herein, a pre-preg is an intermediate material comprised of glass fibers into which resin is impregnated, and is excellent in a strength and electrical insulation. In the first embodiment, the electrically insulating substrate 31 is designed to be 100 micrometers in thickness, and the copper foils 32 and 33 are designed to be 70 micrometers in thickness.

Then, as illustrated in FIG. 12(c), the copper foils 32 and 33 are plated over surfaces thereof with copper 34 and 35 such that a total thickness of the copper foils and the copper with which the copper foils are plated is 100 micrometers. A copper foil having a thickness of 100 micrometers can be employed in place of the combination of the copper foils 32 and 33 and the copper with which the copper foils 32 and 33 are plated, because a copper having a thickness of 100 micrometers can provide the same advantage as that of the combination.

Then, as illustrated in FIG. 12(d), the copper foils 32 and 33 and the coppers 34 and 35 are etched to thereby define electrically conductive patterns. The thus defined electrically conductive patterns are the above-mentioned u-phase and v-phase electrically conductive patterns Pu1 and Pv1.

Then, as illustrated in FIG. 12(e), electrically insulating substrates 36 and 37 are adhered onto the electrically conductive patterns Pu1 and Pv1, and then, copper foils 38 and 39 are adhered to the electrically insulating substrates 36 and 37, respectively. Then, the resultant is pressed into a single piece.

Then, as illustrated in FIG. 12(f), there are formed through holes TH passing across the starting points of the electrically conductive patterns and the leading edges of the lead patterns.

Then, as illustrated in FIG. 12(g), the copper foils 38 and 39 are plated with copper 40 and 41 to thereby define copper layers each having a thickness of 100micrometers, that is, a sum of 70 micrometers as a thickness of the copper foils and 30 micrometers as a thickness of the copper with which the copper foils are plated. Then, the through holes TH are plated with metal.

Then, as illustrated in FIG. 12(h), the copper foils 38 and 39 and the copper 40 and 41 are etched to thereby define electrically conductive patterns (connection lands). The thus defined electrically conductive patterns are the above-mentioned w-phase electrically conductive pattern and the lead patterns Phu1, Plv1 and Plw1.

A second substrate A2 illustrated in FIG. 12(j) is manufactured in accordance with the steps by which the first substrate A1 was manufactured. Then, the first substrate A1, the second substrate A2, and an electrically insulating plate 42 illustrated in FIG. 12(i), sandwiched between the first and second substrates A1 and A2 are pressed into a single piece to thereby manufacture an armature unit including electrically conductive patterns Pu1, Pv1, Pw1, Pu2, Pv2 and Pw2 in three phases and two systems. The thus manufactured armature unit includes six layers of electrically conductive patterns, if only electrically conductive patterns are counted.

The ten armature units are stacked one on another with 36 degrees deviation in an angle of circumference to thereby define an armature including 60 layers of electrically conductive patterns. The armature includes totally 80 layers, if layers of the lead patterns (connection lands) are added into a count in layers. Furthermore, the armature includes 82 layers, if the lead pattern at the starting point and the lead pattern at the termination point are added into a count in layers.

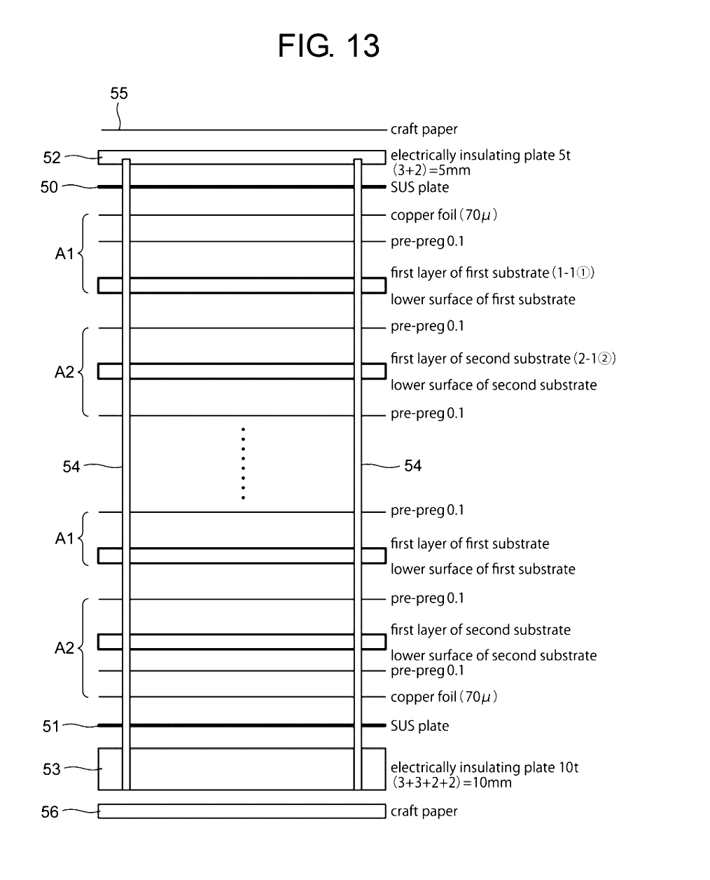

FIG. 13 illustrates a final pressing step among the steps of manufacturing the armature in accordance with the first embodiment of the present invention.

The stacked substrates are sandwiched between SUS plates 50 and 51, as illustrated in FIG. 13, in order to fixedly adhere the substrates illustrated in FIG. 12 to one another. The SUS plates 50 and 51 are further sandwiched between electrically insulating plates 52 and 53. A plurality of poles 54 is caused to extend through the substrates for positioning and supporting the substrates. Then, the electrically insulating plates 52 and 53 are sandwiched between craft papers 55 and 56. Then, the resultant is pressed. After the substrates are fixed to one another, the craft papers 55 and 56, the electrically insulating plates 52 and 53, the poles 54, and the SUS plates 50 and 51 are removed. Thus, there is manufactured a final product.

By fixing a windmill to the rotation shaft 1 in the electric-power generation device having the above-mentioned structure, it is possible to accomplish a wind power generation device capable of rotating even by breeze without cogging.

Furthermore, since a coil can be manufactured to be thin in order to have a high fill factor and to efficiently generate a magnetic system, it is possible to convert a rotational force generated by a windmill into electric power with high efficiency.

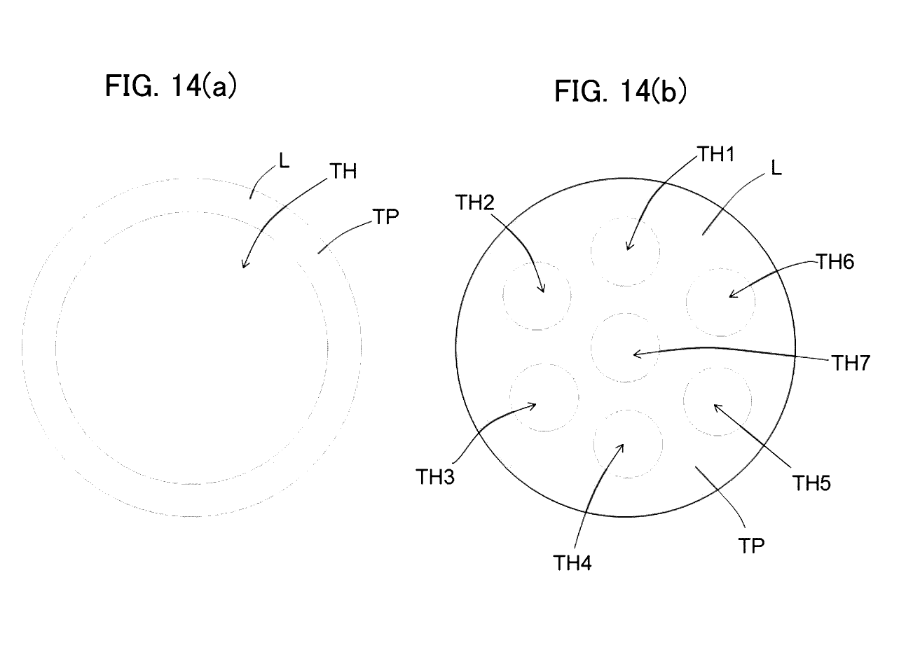

In the first embodiment illustrated in FIG. 12, there are formed the through holes TH passing across a termination point at which the electrically conductive patterns in the substrates are terminated to be wound, and the lead patterns, and the through holes TH are plated with metal to thereby electrically connect the electrically conductive patterns in the substrates to the lead patterns (connection lands) Plu1, Plv1 and Plw1 formed on the substrate situated outermost among the substrates. As illustrated in FIG. 14(a), which is an enlarged plan view, there is generally formed one through hole TH. The substrate situated outermost among the substrates, through which the through hole TH is formed, is formed at a surface thereof with a circular land L, and the through hole TH is plated at an inner surface thereof with metal TP. In the case that a large amount of current, for instance, a current of 10 A to 20 A runs through a coil like the coil in the present invention, if a plated metal had a thickness of about 25 micrometers, a resistance loss would become high, and an efficiency with which rotational force is converted into electric power would be deteriorated.

In order to solve the problem, a substrate in the second embodiment is formed with a plurality of apertures TH1 to TH7 (seven through holes in the second embodiment), as illustrated in FIG. 14(b), and further with a land L plated with copper to entirely cover the through holes TH1 to TH7, and a plated metal TP covering therewith all of inner surfaces of the through holes TH1 to TH7. Thus, the plated metals TP in the through holes TH1 to TH7 are electrically connected in parallel with each other between upper and lower surfaces of the substrates stacked one on another, ensuring that the resistance is reduced down to 57%, and an efficiency with which the rotational force is converted into electric power is enhanced.

In the case that a single through hole having a diameter of 4 mm is formed in the land having a diameter of 5 mm, as illustrated in FIG. 14(a), the through hole has a circumferential length of 25.12 mm. On the other hand, in the case that the seven through holes TH1 to TH7 each having a diameter of 1 mm are formed in the land having a diameter of 5 mm, as illustrated in FIG. 14(b), a total circumferential length of the through holes is 43.69 mm, which is 1.75 times greater than a circumferential length of the single through hole, theoretically ensuring that an electric resistance is reduced in accordance with a difference in a circumferential length.

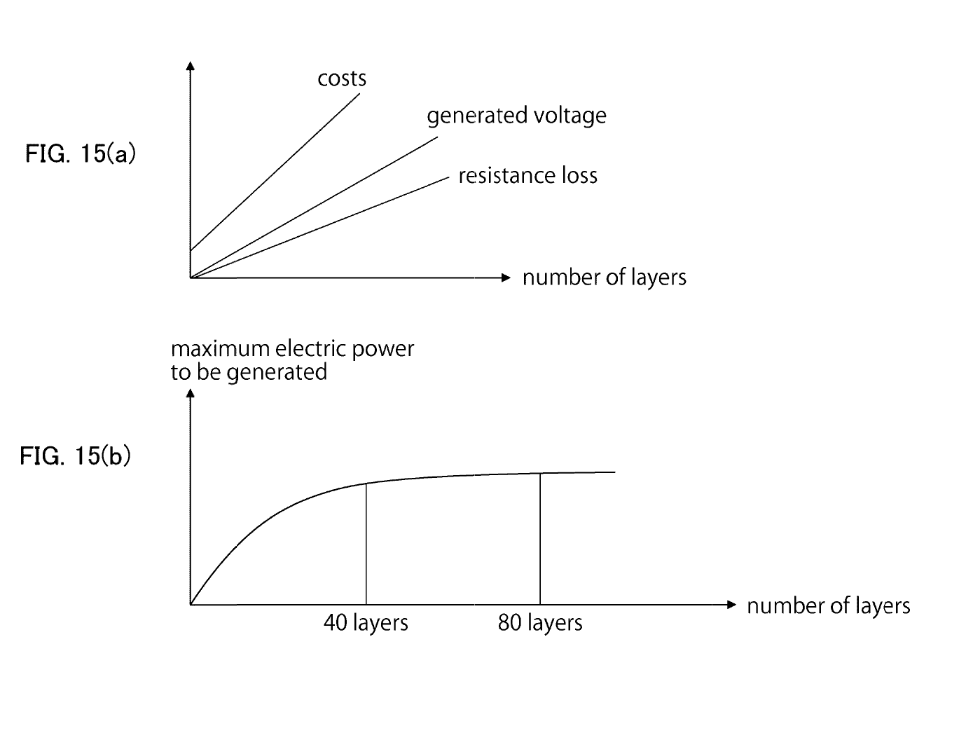

The above-mentioned first embodiment is an example of the armature including sixty layers of the electrically conductive patterns, or eighty layers of both the electrically conductive patterns and the lead patterns of the substrate situated outermost among the substrates, to be manufactured by stacking the ten armature units one on another with 36 degrees deviation in an angle of circumference. In the case that one phase is defined by stacking the substrates one on another with 36 degrees deviation in an angle of circumference, the ten substrates makes one unit (360 degrees). Three phases include a total of thirty layers of the electrically conductive patterns as a number of fundamental layers (forty layers, if layers of the lead patterns of the substrate situated outermost among the substrates are to be added). FIG. 15(a) shows a relation between a number of layers and costs, a voltage to be generated, and a resistance loss. In general, if a number of layers is increased, a voltage to be generated is increased, but a resistance loss is also increased, resulting in that a volume of generated heat is increased, and thus, a temperature rises up. Simultaneously, costs are increased. Thus, a relation between maximum electric power to be generated and a number of layers, specifically, 40 layers and 80 layers shown in the first embodiment was tested. As a result, it was understood, as illustrated in FIG. 15(b), that a peak in maximum electric power to be generated stays flat, even if a number of layers is increased. It was proved that a number of layers in the armature is preferably 40, since a less number of layers is more advantageous with respect to costs.

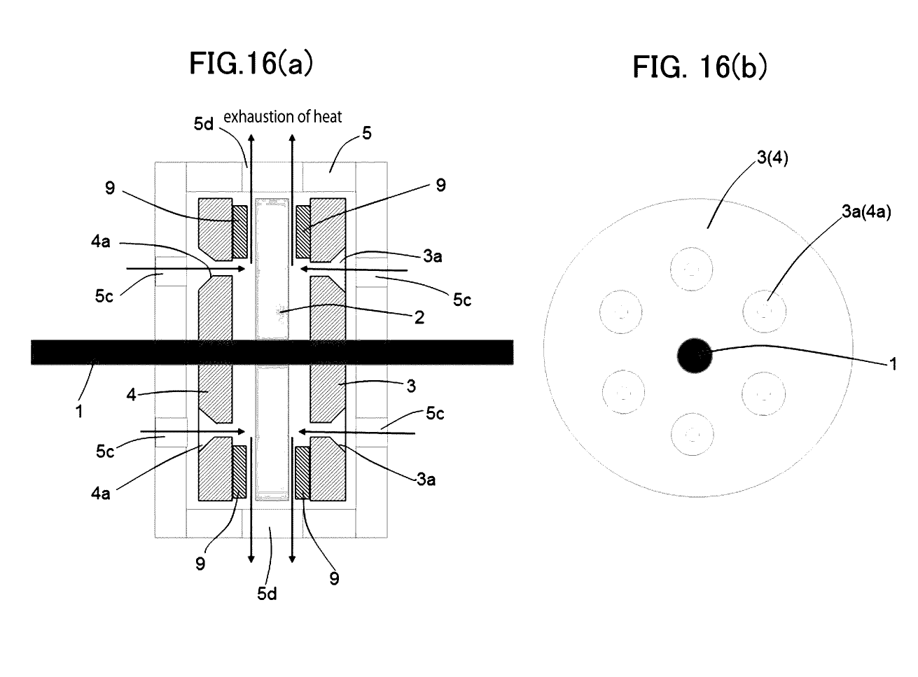

FIGS. 16(a) and 16(b) illustrate a device for generating electric power in accordance with the third embodiment of the present invention, which has an air-cooling structure for cooling heat to be generated at a plurality of the coil substrates stacked in the stator 2. In the third embodiment, the first rotor 3 and the second rotor 4 on both of which the permanent magnets 9 are arranged are formed with air-circulation apertures 3a and 4a both having an increased diameter at a side opposite to the stator 2. In this structure, when the first rotor 3 and the second rotor 4 is caused to rotate by the rotation of the rotation shaft 1, air flows through the air-circulation apertures 3a and 4a by virtue of a difference in pressure across the air-circulation apertures 3a and 4a to thereby generate convection flow. Thus, the coils are cooled down. Furthermore, the casing 5 may be formed with holes 5c through which external air flows into the casing 5 and through which heated air is exhausted out of the casing 5. Even if the casing 5 is not formed with the holes 5c , the casing 5 may be formed with cooling fins for air-cooling the casing 5.

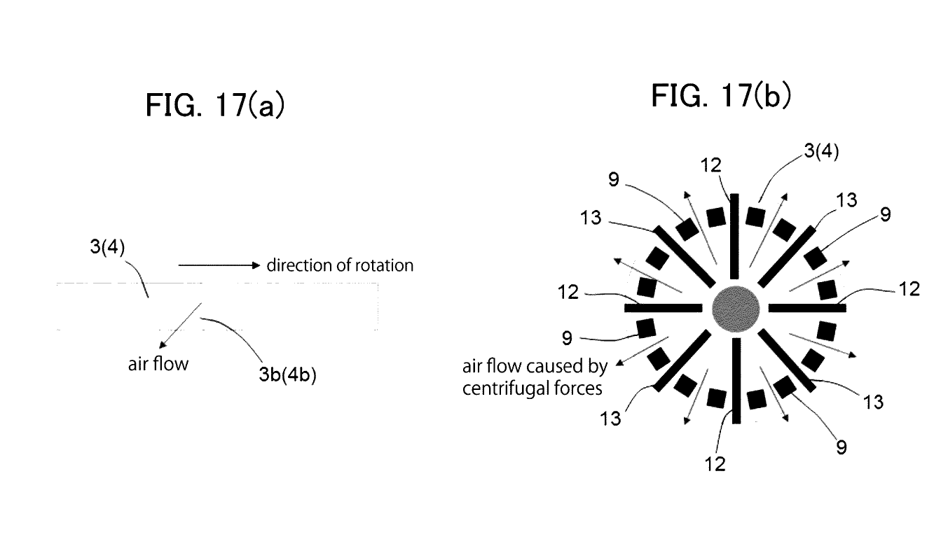

FIGS. 17(a) and 17(b) illustrate another example of the air-cooling structure. As illustrated in FIG. 17(a), air-circulation apertures 3b and 4b to be formed through the first and second rotors 3 and 4, respectively, may be designed to obliquely extend relative to the rotation shaft 1, ensuring that the rotation of the first and second rotors 3 and 4 can effectively cause convection flow of air.

FIG. 17(b) illustrates still another example of the air-cooling structure. The first and second rotors 3 and 4 are formed at surfaces facing the coil substrates (the stator 2) with fins 12 or grooves 13 both extending radially of the first and second rotors 3 and 4. Air flow is generated by the centrifugal forces of the first and second rotors 3 and 4. The first and second rotors 3 and 4 may be formed with one of the fins 12 and the grooves 13, or with both of the fins 12 and the grooves 13.

As mentioned above, the convection flow of air generated by the rotation of the first and second rotors 3 and 4 remove heats generated in a plurality of the coil substrates stacked one on another to define the stator 2, ensuring it possible to prevent reduction in an efficiency of electric power generation.

### INDUSTRIAL APPLICABILITY

The present invention provides a device for generating electric power making it unnecessary to carry out a step of winding a wire for manufacturing a coil, being able to have a higher fill factor than the same of a wire, and preventing occurrence of cogging, and further provides an armature to be equipped in the device. The present invention is suitable to electric power generation such as wind power generation, hydraulic power generation, and tidal power generation.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

### INDICATION BY REFERENCE NUMERALS

1 Rotation shaft
1a Greater-diameter portion
2 Stator
3 First rotor
3a , 3b Air-circulation aperture
4 Second rotor
4a , 4b Air-circulation aperture
5 Casing
5a First casing
5b Second casing
5c Hole
6 Bearing
7 Bush
8 Bolt
9 Permanent magnet
10 First substrate
Cut-out
12 Fin
13 Groove
20 Second substrate
21 Cut-out
31 Electrically insulating substrate
32, 33 Copper foil
34, 35 Copper
36, 37 Electrically insulating substrate
38, 39 Copper foil
40, 41 Copper
50,51 SUS plate
52, 53 Electrically insulating plate
54 Pole
55, 56 Craft paper
TH Through hole
TH1-7 Small through hole
L Connection land

1. A device for generating electric power, including:
a disc-shaped rotor fixed to a rotation shaft;
a magnetic field including an even number of magnetic poles arranged on a common circumference, said magnetic poles comprising permanent magnets fixed to said rotor, being magnetized in a direction in parallel with an axis of said rotor, and being magnetized in alternate directions;
coil substrates on which electrically conductive patterns are formed for each of phases so as to cross magnetic fluxes generated by said magnetic field when said rotor is in rotation,
leading-wire substrates through each of which ends of said electrically conductive patterns of said coil substrates fbr each of phases are extracted outwardly for full phase, and
a stator comprised of said coil substrates in a number equal to a number of said phases and a single substrate comprised of said leading-wire substrate, said coil substrates and said single substrate being stacked one on another,
wherein each of said coil substrates is in the shape of a disc formed with a through hole through which said rotation shaft is fixed,
each of said electrically conductive patterns is defined by a plurality of rows of gear-shaped patterns electrically connected in series to one another, each of said gear-shaped patterns including linear patterns extending radially of said rotation shaft and arcuate patterns extending circumferentially of said rotation shaft such that said linear patterns and said arcuate patterns are alternately arranged to thereby be in the shape of a gear having N teeth equal to a number of said poles, and
said electrically conductive patterns of said coil substrates are formed such that electric power generated in each of phases can be output independently of one another.

2. The device for generating electric power, as set forth in claim 1, wherein two rotors and magnetic fields are respectively spaced away from each other by a predetermined distance in a longitudinal direction of said rotation shaft,
said magnetic fields are arranged such that opposite poles face each other, and
said stator is disposed between said magnetic fields facing each other.

3. The device for generating electric power, as set forth in claim 1, wherein each of said electrically conductive patterns is formed by etching a copper film formed on a printed circuit board.

4. The device for generating electric power, as set forth in claim 1, wherein a plurality of said coil substrates is stacked one on another to define a coil having a predetermined number of turns.

5. The device for generating electric power, as set forth in claim 1, wherein the device includes a plurality of sets of said coil substrate and said rotor to define a coil having a predetermined number of turns.

6. The device for generating electric power, as set forth in claim 1, wherein said stator and said rotor are housed in a cylindrical casing.

7. The device for generating electric power, as set forth in claim 1, wherein said rotation shaft is rotatably supported by said casing through a bearing.

8. The device for generating electric power, as set forth in claim 1, wherein said rotor is formed with an air circulation hole through which an air flows to cool down said coil substrates of said stator.

9. The device for generating electric power, as set forth in claim 1, wherein said rotor is formed with a fin or a groove through which an air flows to cool down said coil substrates of said stator.

10. An armature unit to be equipped in a device for generating electric power, including:
a disc-shaped rotor fixed to a rotation shaft;
a magnetic field including an even number of magnetic poles arranged on a common circumference, said magnetic poles comprising permanent magnets fixed to said rotor, being magnetized in a direction in parallel with an axis of said rotor, and being magnetized in alternate directions; and
a stator including an armature comprising an electric power generating coil crossing magnetic fluxes generated by said magnetic field when said rotor is in rotation,
wherein said electric power generating coil is comprised of electrically conductive patterns formed on a surface of a coil substrate made of an electrically insulative material,
said electrically conductive patterns are formed in dependence on a number of phases,
a leading-wire substrate through which ends of said electrically conductive patterns of said coil substrates for each of phases are extracted outwardly for full phase, is arranged for each of phases,
said stator is comprised of said coil substrates in a number equal to a number of said phases and a single substrate comprised of said leading-wire substrate, said coil substrates and said single substrate being stacked one on another,
wherein each of said coil substrates is in the shape of a disc formed with a through hole through which said rotation shaft is fixed,
each of said electrically conductive patterns is defined by a plurality of rows of gear-shaped patterns electrically connected in series to one another, each of said gear-shaped patterns including linear patterns extending radially of said rotation shaft and arcuate patterns extending circumferentially of said rotation shaft such that said linear patterns and said arcuate patterns are alternately arranged to thereby be in the shape of a gear having N teeth equal to a number of said poles, and
said electrically conductive patterns of said coil substrates are formed such that electric power generated in each of phases can be output independently of one another.

11. The armature unit as set forth in claim 10, wherein electrically insulative layers and electrically conductive layers each including an electrically conductive pattern are alternately stacked one on another, and a point at which an electrically conductive pattern terminates to be wound in a layer is electrically connected through a plated through hole to a point at which an electrically conductive pattern starts to be wound in a next layer in a common phase to thereby define an electrically conductive pattern having a predetermined number of turns.

12. The armature unit as set forth in claim 11, wherein said electric power generating coil includes four electrically conductive patterns, and an electrically conductive pattern situated outermost among said four electrically conductive patterns includes an electrically conductive layer on which a connection land is formed through an electrically insulative layer.

13. The armature unit as set forth in claim 11, wherein a through hole through which a point at which an electrically conductive pattern in a layer terminates to be wound and a point at which an electrically conductive pattern in a next layer starts to be wound are electrically connected to each other, or through which said electrically conductive pattern situated outermost among said four electrically conductive patterns is electrically connected to said connection land is comprised of a plurality of apertures, each of which plated to electrically connect to said connection land.

14. A method of manufacturing an armature unit to be equipped in a device for generating electric power, including:
adhering first and second metal layers onto upper and lower surfaces of an electrically insulative substrate;
etching said first and second metal layers to form first and second electrically conductive patterns each having a function of a first-phase electric power generating coil and a second-phase electric power generating coil, respectively;
coating electrically insulative layers on upper and lower surfaces of said first and second electrically conductive patterns;
adhering third and fourth metal layers onto upper and lower surfaces of each of said electrically insulative layers;
etching said third and fourth metal layers to form third and fourth electrically conductive patterns, said third electrically conductive pattern having a function of a third-phase electric power generating coil, said fourth electrically conductive pattern having a function of a lead pattern; and
electrically connecting a point at which each of said first to third electrically conductive patterns starts or terminates to be wound, to said fourth electrically conductive pattern through a plated through hole.

15. A method of manufacturing an armature unit to be equipped in a device for generating electric power, including stacking a requisite number of armatures one on another to define an electric power generating coil having a predetermined number of turns, said armature being manufactured in accordance with the method set forth in claim 14.

16. A method of manufacturing an armature unit to be equipped in a device for generating electric power, including stacking fifth, sixth and seventh electrically conductive patterns onto said first, second and third electrically conductive patterns to lay each of phases in said first to third electrically conductive patterns over each of phases in said fifth to seventh electrically conductive patterns,
said fifth, sixth and seventh electrically conductive patterns each having tops and bottoms located oppositely to tops and bottoms of said first., second and third electrically conductive patterns, respectively, in the case that said armature unit manufactured in accordance with the method set forth in claim 14 includes electrically conductive patterns having alternately located tops and bottoms.
